(19) United States
(12) Patent Application Publication
(10) Pub. No.: US 2025/0060996 A1
(43) Pub. Date: Feb. 20, 2025

(54) DYNAMIC LOAD SCHEDULING USING CARBON INTENSITY DECOMPOSITION

(71) Applicant: International Business Machines Corporation, Armonk, NY (US)

(72) Inventors: Eun Kyung Lee, Bedford Corners, NY (US); Ramachandra Rao Kolluri, Cranbourne East (AU); Julian de Hoog, Greensborough (AU); Arun Vishwanath, Nunawading (AU)

(21) Appl. No.: 18/451,367

(22) Filed: Aug. 17, 2023

(51) Int. Cl. G06F 9/48; G06F 17/11

(52) U.S. Cl. CPC G06F 9/4893; G06F 17/11

(57) ABSTRACT

Systems and techniques that facilitate dynamic load scheduling are provided. For example, one or more embodiments described herein can comprise a system, which can comprise a memory that can store computer executable components. The system can also comprise a processor, operably coupled to the memory that can execute the computer executable components stored in memory. The computer executable components can comprise a carbon footprint component that generates estimated carbon footprints of a plurality of tasks for a plurality of datacenters based on carbon intensity forecasts and estimated workload requirements of the task, wherein the carbon intensity forecasts comprise ancillary carbon output, marginal carbon output, and average carbon output; and a scheduling component that schedules the plurality of tasks for one or more datacenters selected from the plurality of datacenters based on the estimated carbon footprints.

### BACKGROUND

The subject disclosure relates to workload scheduling, and more specifically, load scheduling based on carbon intensity of power generation.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate dynamic load scheduling using carbon intensity are provided.

According to an embodiment, a computer-implemented method can comprise generating, by a system operatively coupled to a processor, estimated carbon footprints of a plurality of tasks for a plurality of datacenters based on carbon intensity forecasts and estimated workload requirements of the task, where the carbon intensity forecasts comprise ancillary carbon output, marginal carbon output, and average carbon output. The computer-implemented method can further comprise scheduling, by the system, the plurality of tasks for one or more datacenters selected from the plurality of datacenters based on the estimated carbon footprints.

Additional aspects of the present disclosure are directed to systems and computer program products configured to perform the method described above. The present summary is not intended to illustrate each aspect of, every implementation of, and/or every embodiment of the present disclosure.

### DESCRIPTION OF THE DRAWINGS

FIG. 1 illustrates a block diagram of an example, non-limiting system that can facilitate dynamic load scheduling in accordance with one or more embodiments described herein.

FIG. 2 illustrates a chart showing the ancillary, marginal and average carbon intensities of a geographic region in accordance with one or more embodiments described herein.

FIG. 3 illustrates maps showing examples of different carbon intensities for different regions in accordance with one or more embodiments described herein.

FIG. 4 illustrates a chart showing carbon intensities of different fuel sources in accordance with one or more embodiments described herein.

FIG. 5 illustrates a graph showing the carbon intensity of various cities over a period of time in accordance with one or more embodiments described herein.

FIG. 6 illustrates a diagram showing how multiple carbon intensities can be utilized based on different time intervals in accordance with one or more embodiments described herein.

FIG. 7 illustrates a chart comparing the performance of carbon footprint accounting as described herein against other methods utilizing on average carbon intensity in accordance with one or more embodiments described herein.

FIG. 8 illustrates a flow diagram of an example, non-limiting, computer implemented method that can facilitate dynamic task scheduling in accordance with one or more embodiments described herein.

FIG. 9 illustrates a flow diagram of an example, non-limiting, computer implemented method that facilitates dynamic task scheduling in accordance with one or more embodiments described herein.

FIG. 10 illustrates a flow diagram of an example, non-limiting, computer implemented method that facilitates dynamic task scheduling in accordance with one or more embodiments described herein.

FIG. 11 illustrates an example, non-limiting environment for the execution of at least some of the computer code in accordance with one or more embodiments described herein.

FIG. 12 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

Currently, various industries and entities are interested in tracking and/or minimizing the carbon footprint of their activities based on power consumption and the source of power generation. Various geographic regions have their own mix of power generation sources (e.g., coal, nuclear, petroleum, solar etc.). Each of these fuels has its own carbon intensity which reflects how many grams of CO₂ are emitted per unit of energy generated. For different regions, these values can be applied as weights to the different types of energy generation, and thus each region has its own carbon intensity. For applications such as load scheduling across multiple global data centers, understanding and tracking the carbon intensity of various regions is important for carbon footprint accounting and minimization. Current load scheduling methods utilize the average carbon intensity over long time scales as part of carbon accounting which can lead to inaccuracies as various changes in power demand can drastically impact carbon intensity of power generation in the short term. For example, electrical power suppliers may react to sudden spikes in power demand by activating short term or intermediate term power sources, which may have different carbon intensities than the long term average.

In view of the problems discussed above, the present disclosure can be implemented to produce a solution to one or more of these problems by generating estimated carbon footprints of a plurality of tasks for a plurality of datacenters based on carbon intensity forecasts and estimated workload requirements of the task, wherein the carbon intensity forecasts comprise ancillary carbon output, marginal carbon output, and average carbon output, and scheduling the plurality of tasks for one or more datacenters selected from the plurality of datacenters based on the estimated carbon footprints.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

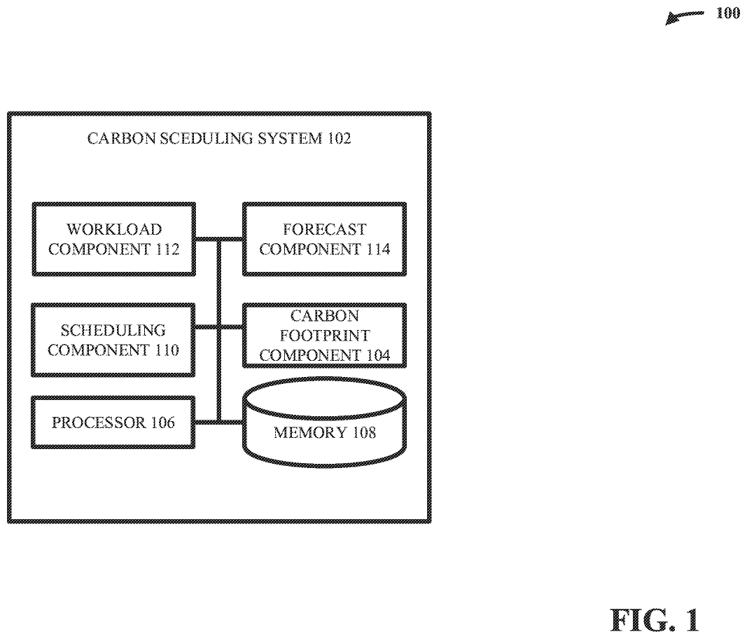

FIG. 1 illustrates block diagram of an example, non-limiting system 100 that can facilitate dynamic load scheduling in accordance with one or more embodiments described herein. Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise carbon footprint component 104, scheduling component 110, workload component 112, forecast component 114, processor 106 and memory 108.

In various embodiments, dynamic load scheduling system 102 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the system 102 (e.g., carbon footprint component 104, scheduling component 110, workload component 112, and/or forecast component 114) to perform one or more acts. In various embodiments, the memory 108 can store computer-executable components (e.g., carbon footprint component 104, scheduling component 110, workload component 112, and/or forecast component 114), the processor 106 can execute the computer-executable components.

In one or more embodiments, forecast component 114 can generate carbon intensity forecasts for a plurality of datacenters, wherein the carbon intensity forecasts comprise ancillary carbon output, marginal carbon output, and average carbon output. As described above, as part of balancing electrical grids, regions utilize different power sources at different times in order to meet demand. For example, one type of power generation may be used to meet unexpected spikes in demand, while other forms may be used to meet intermediate or long term demands. As utilized herein, ancillary carbon output can define short term power usage (e.g., sources used to meet short term or unexpected power requirements), marginal carbon output can define intermediate term power usage, and average carbon output can define long term power usage (e.g., the standard market clearing source and/or average carbon intensity of all sources used). In one or more embodiments, forecast component 114 and/or an entity can define time scales for short term, intermediate term, and long term. For example, short term can be defined as 2 minutes or less, intermediate term can be defined as between 2 and 5 minutes, and long term can be defined as greater than 5 minutes. It should be appreciated that used of any defined lengths of time or intervals is envisioned. Accordingly, forecast component 114 can utilize publicly available data on different power sources utilized and how different length power demand spikes are met for different regions to develop carbon intensity forecasts for one or more regions in which relevant datacenters are located. For example, a first region may use natural gas for long term power generation and utilize hydroelectric power to meet short term demands, while a second region may use coal plants for long term power generation and utilize wind power for short term demands. Furthermore, the ancillary, marginal and average power sources and/or carbon intensities can vary based on time of day or day to day. For example, a geographic region may use natural gas as an ancillary power source during the morning, and use solar power during the afternoon.

In one or more embodiments, workload component 112 can generate estimated workload requirements for a plurality of tasks for a plurality of datacenters. For example, given a set of existing workloads or tasks and a list of anticipated workloads or tasks, workload component 112 can generate estimates of when a particular data center can perform a task, how long it would take to perform the task (e.g., runtime duration), the power requirements to operate the datacenter for the duration, and how urgent or flexible the scheduling of the task can be (e.g., an urgency level of the task). For example, different datacenters may have different hardware and/or software configurations that may have different runtime durations and/or power consumption requirements. Additionally, workload component 112 can assess the number of tasks already scheduled for a datacenter or expected to be scheduled for a datacenter to determine which datacenters are available to perform tasks. In one or more embodiments, workload component 112 can utilize a database of past task workload requirements to generate the estimated workload requirements. In another embodiment, an entity can input one or more workload requirements for a task to the workload component 112. Furthermore, in some embodiments, workload component 112 can utilize a machine learning model to generate the estimated workload requirements based on requirements of previous tasks.

Once the carbon forecasts and estimated workload requirements have been generated, then carbon footprint component 104 can generate estimated carbon footprints of the plurality of tasks for the plurality of tasks. In an embodiment, the carbon footprint component 104 can generate an ancillary carbon footprint, a marginal carbon footprint and an average carbon footprint for each task, for each datacenter. For example, given a task with an estimated run time of 10 minutes, wherein ancillary carbon output is used for 2 minutes or less, marginal carbon output is used for between 2 and 5 minutes, and average carbon output is used for 5 minutes or more, carbon footprint component 104 can generate an estimated carbon footprint of the task by adding the ancillary carbon output for the first 2 minutes of the task duration, the marginal carbon output for minutes 2 through 5 and the average carbon output for minutes 5 through 10 to generate the estimated carbon footprint of running the task for 10 minutes.

In a further embodiment, the carbon intensity forecast can be defined as CI(t) wherein t is the 1 minute resolution timestamp of a carbon intensity timeseries. The forecast horizon is assumed to be greater than 1 min and less than 2 hours (where possible the forecast horizon can be longer without compromising the accuracy at the desired high resolution). Accordingly, an estimated power consumption to perform the task w can be estimated using the estimated workload requirements determined by workload component 112 defined as Start time within the forecast horizon (α), level of flexibility (β), anticipated runtime (γ) if using a resource (δ) (therefore [γ, δ] are used together), and deadline within the forecast horizon (η). All of the above factors can be considered to be discrete variables. Therefore, for the given workload or task w, multiple power consumption timeseries can be developed using combination of the above factors. Power consumption for each such feasible combination xw is given by P(w,x_{w})(t) where x_{w}=[α, β, (γ, δ), η]. Therefore, each power consumption time series. P(w,x_{w})(t), is converted into energy consumption time series, E(w,x_{w})(t) using the time step difference. The carbon footprint of each possible combination of a workload is calculated using the formula: CF_{w,x}_{_{w}}(t)=E_{(w,x}_{_{w}}₎(t)×CI(t)×PUE(t), where PUE(t) is the power usage effectiveness forecast timeseries for the given data center.

In an embodiment, scheduling component 110 can schedule one or more tasks for performance on one or more datacenters based on the estimated carbon footprints. For example, given the estimated carbon footprints for performance of the tasks at different times on different datacenters, the scheduling component 110 can schedule the task for different datacenters and/or performance times in order to decrease the total carbon foot of all the tasks. In an embodiment, given a plurality of workloads or tasks from a set W, and CF_{w,x}_{_{w}}(t) as determined above by the carbon footprint component 104, scheduling component 110 can solve a mixed integer linear program to determine a combination of tasks and datacenters that minimizes the overall carbon footprint. For example, the scheduling component 110 can minimize ix_{w}×CF_{w,x}_{_{w}}(t)∀W, t such that Σix_{w}=1 ∀I_{w}, wherein w=workload index, the set of workloads is W, x_{w}=feasible combination drawn from the set of feasible combinations available to compute workload w, X_{w}, ix_{w}=binary variable. 1 when x_{w} is selected for a given workload w or otherwise, the set of all ix_{w} for a workload w is denoted by I_{w}, and CF_{w,x}_{_{w}}(t)=carbon footprint of workload w using the feasible combination x_{w} at carbon intensity CI(t) and power usage effectiveness PUE(t). If one feasible combination x_{w1} compromises the feasibility of another workload's feasibility combination, say x_{w2}, the one with the lowest cumulative energy is retained. Once a combination is selected, scheduling component 110 can notify the plurality of datacenters of the scheduling and initiate loading or transferring of data for a task from one datacenter to the datacenter the task is scheduled for. By moving loads only after the schedule is determined, scheduling component 110 decreasing the number of operations performed by the system, therefore decreasing the workloads of processors and/or memories utilized by the various datacenters.

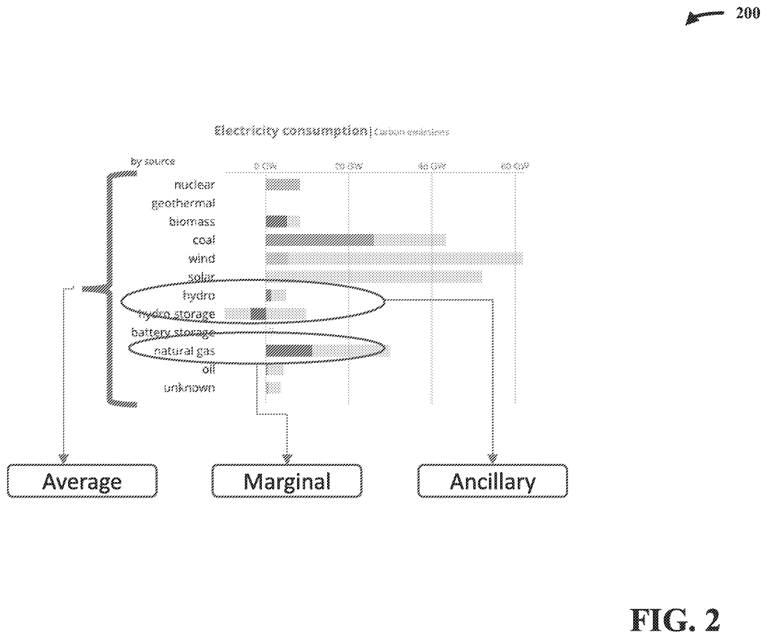

FIG. 2 illustrates a chart 200 showing the ancillary, marginal and average carbon intensities of a geographic region in accordance with one or more embodiments described herein.

As shown, chart 200 illustrates various types of power generation sources utilized by a specific region. One or more power sources may be designated as ancillary (e.g., power sources utilized to meet short term needs or spikes), here illustrated as hydro and hydro storage. Furthermore, one or more power sources may be designated as marginal (e.g., power sources utilized to meet intermediate time scale increases), here illustrates as natural gas. It should be appreciated that what power sources are designated as ancillary and/or marginal may vary by geographic regions and can be identified though publicly available information. The average then constitutes the average of all power sources together.

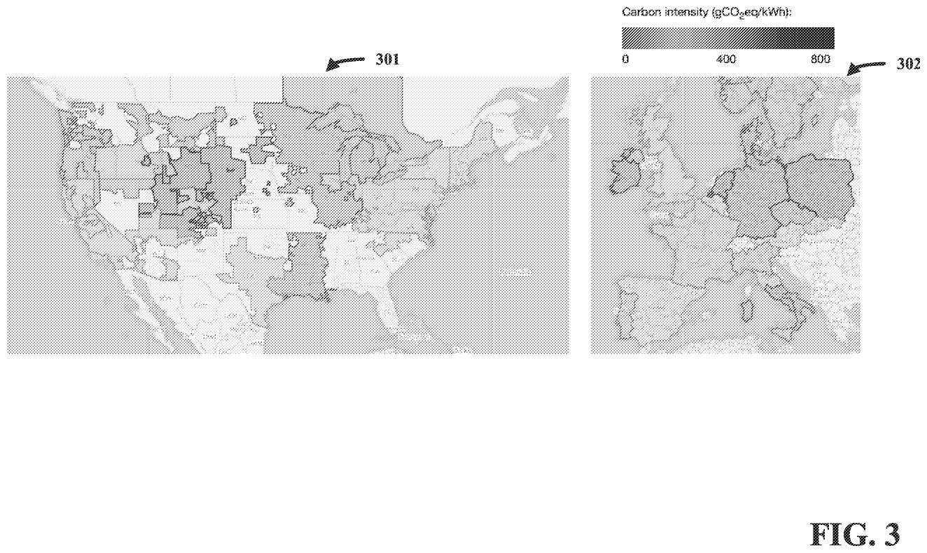

FIG. 3 illustrates maps 301 and 302 showing examples of different carbon intensities for different regions in accordance with one or more embodiments described herein.

As shown, carbon intensities can vary by country, as shown by map 302, or by specific regions within a single country, as shown by map 301. Accordingly, the selection of which datacenter is used to perform a task can be very impactful on the overall carbon footprint of a task or plurality of tasks.

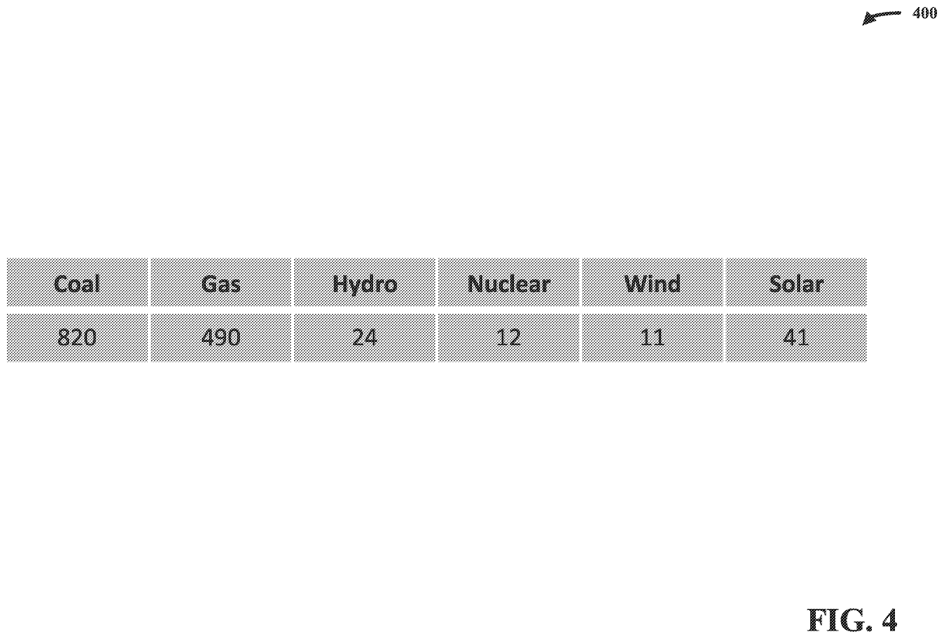

FIG. 4 illustrates a chart 400 showing carbon intensities of different fuel sources in accordance with one or more embodiments described herein.

Chart 400 illustrates the grams of CO₂ which are emitted per unit of energy generated by the listed fuel sources. As shown, the amount of CO₂ emitted can vary greatly, and as such, selection of datacenters in different regions at different times can have a large impact on overall carbon footprint of a plurality of tasks.

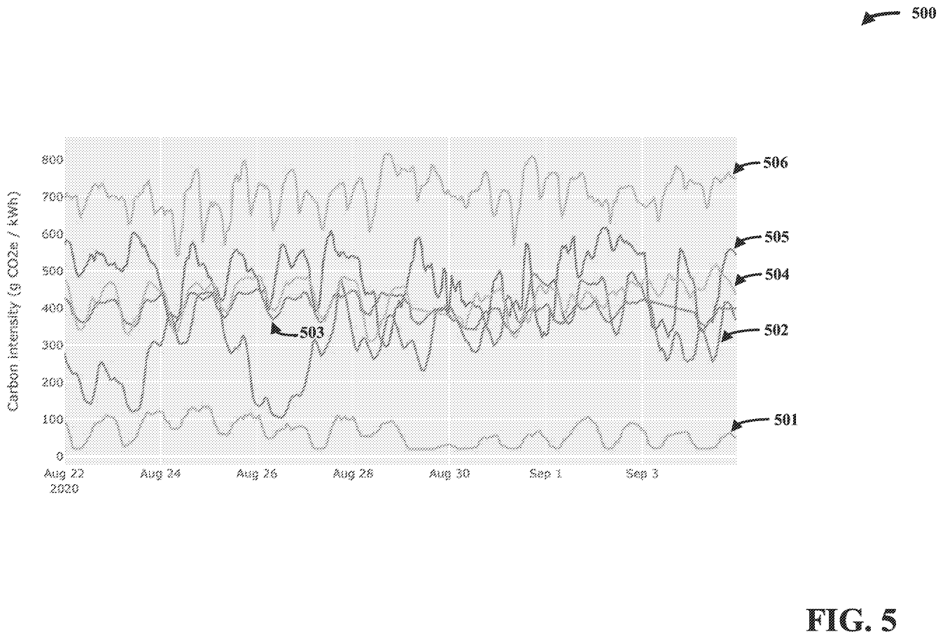

FIG. 5 illustrates a graph 500 showing the carbon intensity of various cities over a period of time in accordance with one or more embodiments described herein.

Line 501 of graph 500 shows the carbon intensity of Toronto, Canada, line 502 shows the carbon intensity of Frankfurt, Germany, line 503 shows the carbon intensity of Washington DC, USA, line 504 shows the carbon intensity of Dallas, USA, line 505 shows the carbon intensity of Boulder, USA and line 506 shows the carbon intensity of Sydney, Australia. As shown by the various line of graph 500, the carbon intensity of regions and/or cities can vary both day to day and based on time of day. Accordingly, accounting for the exact time of day a task is performed can lead to more accurate accounting of the carbon footprint of datacenters.

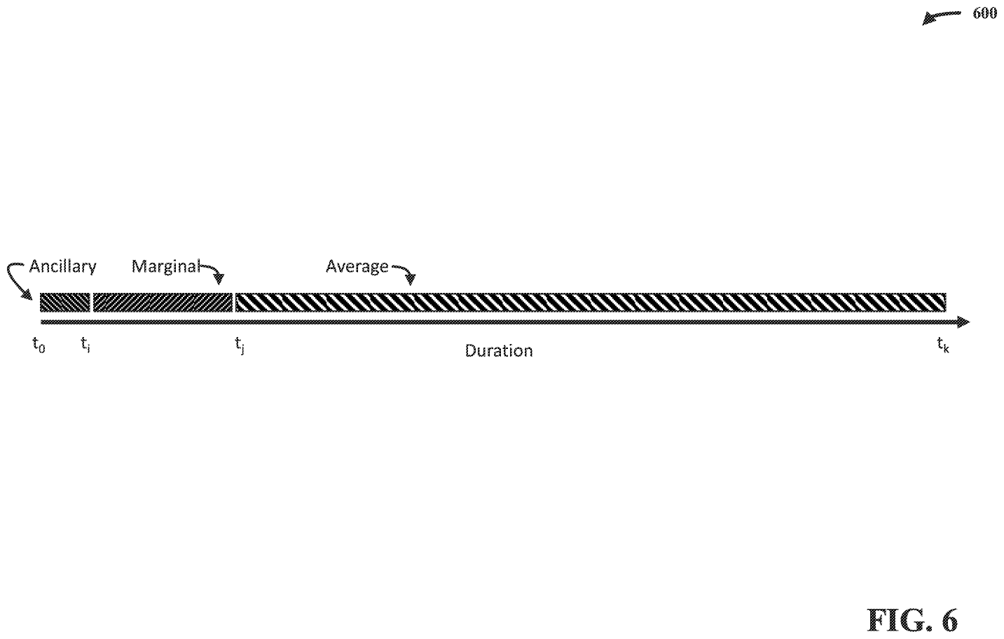

FIG. 6 illustrates a diagram 600 showing how multiple carbon intensities can be utilized based on different time intervals in accordance with one or more embodiments described herein.

Diagram 600 illustrates an estimated time duration of a task tₖ. As described above in reference to FIG. 1, over a short time interval, shown here as between t₀ and tᵢ, the ancillary carbon intensity can be utilized, over an intermediate interval, shown here as between tᵢ and tⱼ, the marginal carbon intensity can be utilized, and for long term intervals, shown here as any time past tⱼ, the average carbon intensity can be utilized. In one or more embodiments, the time values of tᵢ and tⱼ can be specified by an entity and/or may be defined separately for each region or datacenter being considered.

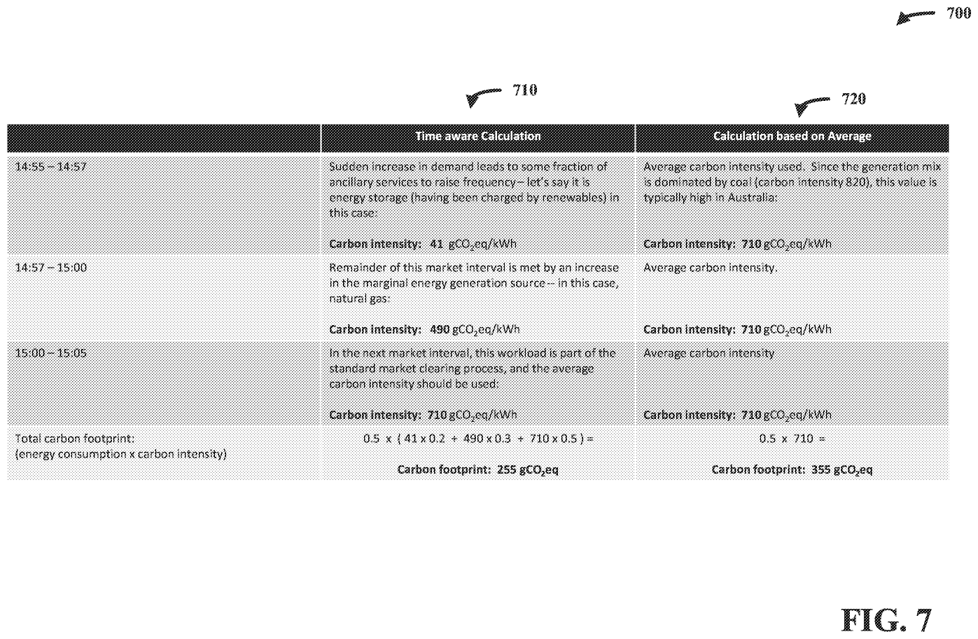

FIG. 7 illustrates a chart 700 comparing the performance of carbon footprint accounting as described herein against other methods utilizing average carbon intensity in accordance with one or more embodiments described herein.

Chart 700 illustrates carbon footprint accounting of a task with a runtime of 10 minutes, and a total energy consumption of 0.5 kWh, wherein tᵢ is defined as 2 minutes and tⱼ is defined as 5 minutes. As shown by column 710, for carbon footprint accounting as described herein, for the time period between t₀ and tᵢ (e.g., 14:55-14:57) the ancillary intensity is used, for the time period between t₁ and tⱼ (e.g., 14:57-15:00) the marginal intensity is used, and for the time period after tⱼ until completion (e.g., 15:00-15:05) the average intensity is used, leading to a calculated carbon footprint of 255 g of CO₂. In contrast, column 720 shows a calculation using the average intensity for the entire duration, leading to a calculated carbon footprint of 355 g of CO₂. As shown by this difference, the carbon footprint accounting method as described herein can more accurately calculate carbon footprints of tasks, thereby enabling more accurate accountability and better management of task scheduling.

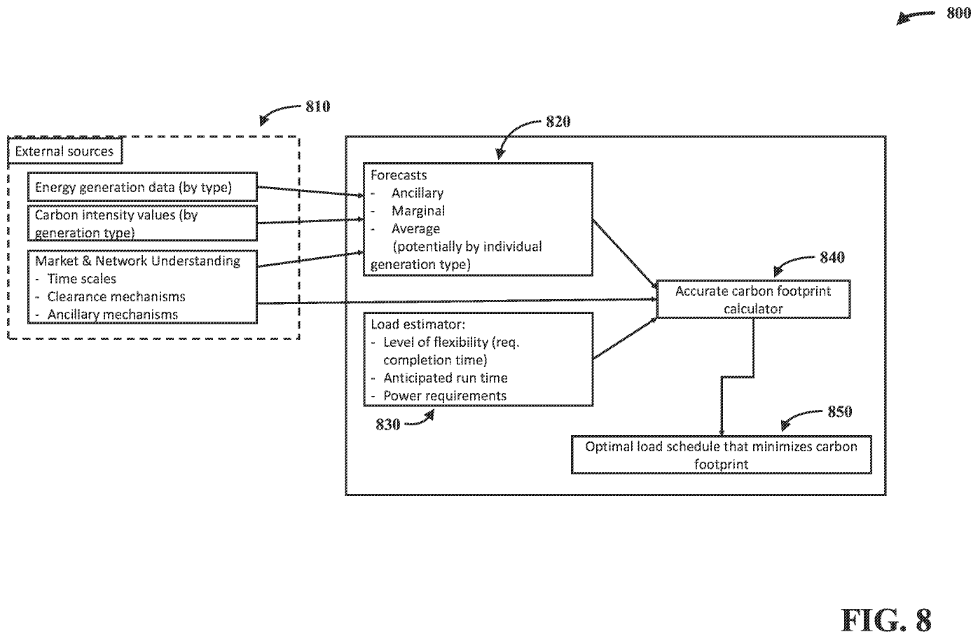

FIG. 8 illustrates a flow diagram 800 of an example, non-limiting, computer implemented method that can facilitate dynamic task scheduling in accordance with one or more embodiments described herein.

As shown, at 810, data from external sources such as energy generation data, carbon intensity data, and/or electrical market information can be collected (e.g., by forecast component 114) in order to produce carbon intensity forecasts 820. Load estimator 830 (e.g., workload component 112) can then estimate workload factors such as level of flexibility, anticipated runtime and/or power requirements for the plurality of tasks. At 840, carbon footprints for performing the plurality of tasks on the plurality of datacenters can then be calculated (e.g., by carbon footprint component 104) and at 850 a load schedule that minimizes the overall carbon footprint can selected (e.g., by scheduling component 110).

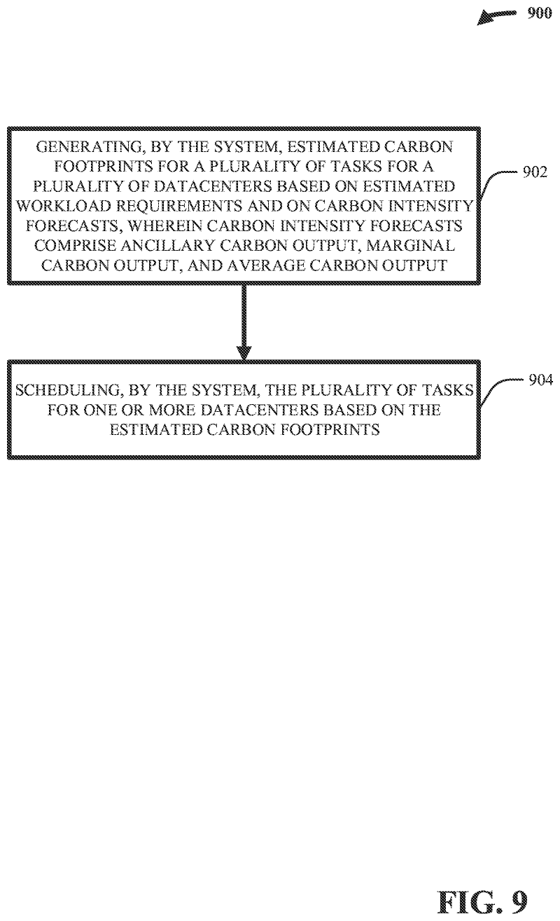

FIG. 9 illustrates a flow diagram of an example, non-limiting, computer implemented method 900 that facilitates dynamic task scheduling in accordance with one or more embodiments described herein.

At 902, method 900 can comprise generating, by a system (e.g., system 102 and/or carbon footprint component 104) operatively coupled to a processor (e.g., processor 106), estimated carbon footprints for a plurality of tasks for a plurality of datacenters based on estimated workload requirements and on carbon intensity forecasts. For example, as described above in greater detail in relation to FIG. 1, carbon footprint component 104 can utilize ancillary carbon intensities, marginal carbon intensities and average carbon intensities related to the plurality of datacenters, estimated runtimes of the tasks, estimated power consumption to perform the task, and other factors to calculate carbon footprints for performing each of the plurality of tasks on each of the datacenters.

At 904, method 900 can comprise scheduling, by the system (e.g., system 102 and/or scheduling component 110), the plurality of tasks for one or more datacenters based on the estimated carbon footprints. For example, as described above in greater detail in reference to FIG. 1, scheduling component 110 can utilize the carbon footprints to solve a minimization problem to determine a combination of tasks and datacenters that has the smallest overall carbon footprint. The scheduling component 110 can then schedule the plurality of tasks for the one or more datacenters based on the determined combination.

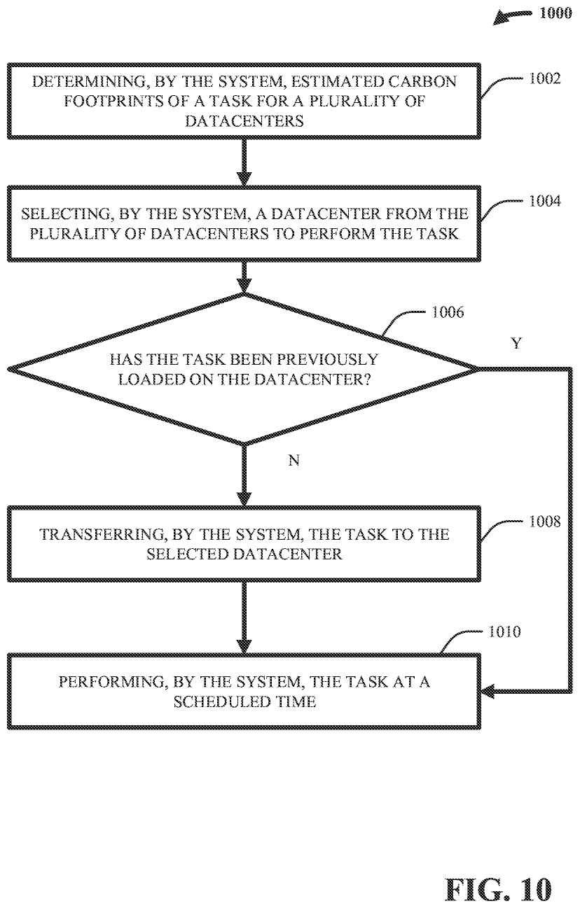

FIG. 10 illustrates a flow diagram of an example, non-limiting, computer implemented method 1000 that facilitates dynamic task scheduling in accordance with one or more embodiments described herein.

At 1002, method 1000 can comprise determining, by a system (e.g., system 102 and/or carbon footprint component 104) operatively coupled to a processor (e.g., processor 106), estimated carbon footprints of a task for a plurality of datacenters. For example, as described above in greater detail in relation to FIG. 1, carbon footprint component 104 can utilize ancillary carbon intensities, marginal carbon intensities and average carbon intensities related to the plurality of datacenters, estimated runtimes of the task, estimated power consumption to perform the task, and other factors to calculate carbon footprints for performing the task on each of the datacenters.

At 1004, method 1000 can comprise selecting, by the system (e.g., system 102 and/or scheduling component 110), a datacenter from the plurality of datacenters to perform the task. For example, as described in greater detail in reference to FIG. 1, scheduling component 110 can select a datacenter to perform the task based on datacenter availability and the carbon footprints of the task in order to minimize overall carbon footprint.

At 1006, method 1000 can comprise determining, by the system (e.g., system 102 and/or scheduling component 110), whether the task has been previously loaded on the selected datacenter. If the task has been previously loaded on the datacenter (e.g., was most recently performed on the selected datacenter) then method 1000 can proceed to step 1010 and the datacenter can perform the task at the scheduled time. If the task has not been previously loaded on the datacenter, then method 1000 can proceed to step 1008 and transfer the task to the selected datacenter before continuing to step 1010.

System 102 can provide technical improvements to a processing unit associated with system 102. For example, by utilizing limiting load transfer operations until after determination of a schedule for performance of the tasks, the number of load transfer operations are reduced, thereby reducing the workload of a processing unit (e.g., processor 106) that is employed to execute routines (e.g., instructions and/or processing threads) involved in dynamic load scheduling. System 102 can thereby facilitate improved performance, improved efficiency, and/or reduced computational cost associated with such a processing unit.

It is to be appreciated that system 102 can utilize various combination of electrical components, mechanical components, and circuitry that cannot be replicated in the mind of a human or performed by a human as the various operations that can be executed by system 102 and/or components thereof as described herein are operations that are greater than the capability of a human mind. For instance, the amount of data processed, the speed of processing such data, or the types of data processed by system 102 over a certain period of time can be greater, faster, or different than the amount, speed, or data type that can be processed by a human mind over the same period of time. According to several embodiments, system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that system 102 can include information that is impossible to obtain manually by an entity, such as a human user. For example, the type, amount, and/or variety of information included in system 102 can be more complex than information obtained manually by an entity, such as a human user.

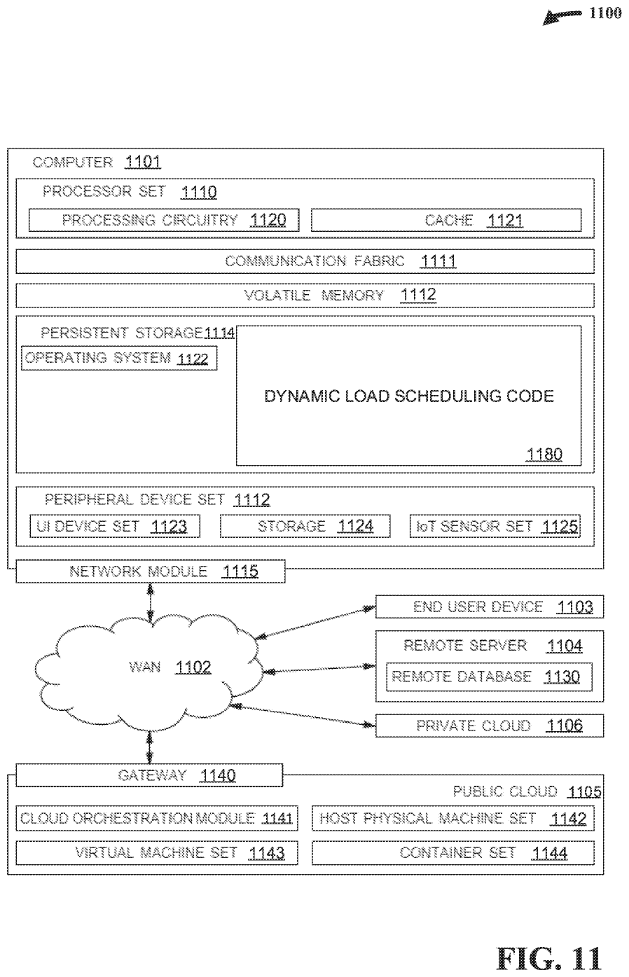

FIG. 11 and the following discussion are intended to provide a brief, general description of a suitable computing environment 1100 in which one or more embodiments described herein at FIGS. 1-10 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as translation of an original source code based on a configuration of a target system by the dynamic load scheduling code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1114 (including operating system 1122 and block 1180, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method can be distributed among multiple computers and/or between multiple locations. On the other hand, in this presentation of computing environment 1100, detailed discussion is focused on a single computer, specifically computer 1101, to keep the presentation as simple as possible. Computer 1101 can be located in a cloud, even though it is not shown in a cloud in FIG. 11. On the other hand, computer 1101 is not required to be in a cloud except to any extent as can be affirmatively indicated.

PROCESSOR SET 1110 includes one, or more, computer processors of any type now known or to be developed in the future. Processing circuitry 1120 can be distributed over multiple packages, for example, multiple, coordinated integrated circuit chips. Processing circuitry 1120 can implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set can be located “off chip.” In some computing environments, processor set 1110 can be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods can be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory can be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 can be a read only memory (ROM), but typically at least a portion of the persistent storage allows writing of data, deletion of data and re-writing of data. Some familiar forms of persistent storage include magnetic disks and solid-state storage devices. Operating system 1122 can take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 can include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 can be persistent and/or volatile. In some embodiments, storage 1124 can take the form of a quantum computing storage device for storing data in the form of qubits. In embodiments where computer 1101 is required to have a large amount of storage (for example, where computer 1101 locally stores and manages a large database) then this storage can be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor can be a thermometer and another sensor can be a motion detector.

NETWORK MODULE 1115 is the collection of computer software, hardware, and firmware that allows computer 1101 to communicate with other computers through WAN 1102. Network module 1115 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and can take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 can be a client device, such as thin client, heavy client, mainframe computer and/or desktop computer.

REMOTE SERVER 1104 is any computer system that serves at least some data and/or functionality to computer 1101. Remote server 1104 can be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data can be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs can be stored as images and can be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware and firmware allowing public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

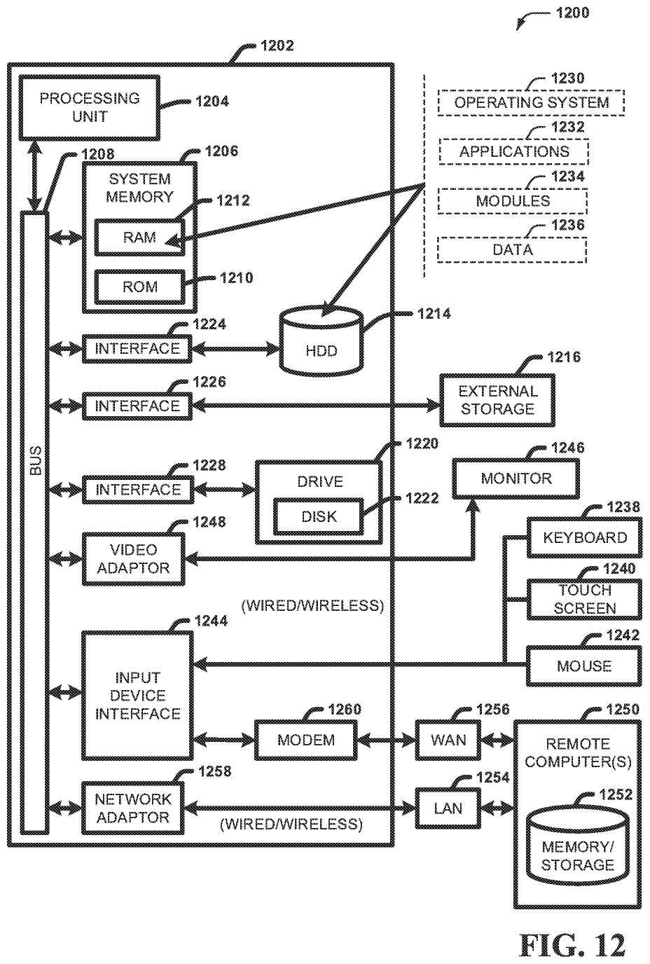

In order to provide a context for the various aspects of the disclosed subject matter, FIG. 12 as well as the following discussion are intended to provide a general description of an alternative suitable environment in which the various aspects of the disclosed subject matter can be implemented. FIG. 12 illustrates a block diagram of an example, non-limiting operating environment in which one or more embodiments described herein can be facilitated. Repetitive description of like elements employed in other embodiments described herein is omitted for sake of brevity.

With reference to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and a drive 1220, e.g., such as a solid state drive, an optical disk drive, which can read or write from a disk 1222, such as a CD-ROM disc, a DVD, a BD, etc. Alternatively, where a solid state drive is involved, disk 1222 would not be included, unless separate. While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and drive 1220 can be connected to the system bus 1208 by an HDD interface 1224, an external storage interface 1226 and a drive interface 1228, respectively. The interface 1224 for external drive implementations can include at least one or both of Universal Serial Bus (USB) and Institute of Electrical and Electronics Engineers (IEEE) 1294 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1294 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above, such as but not limited to a network virtual machine providing one or more aspects of storage or processing of information. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components;
a processor that executes computer executable components stored in the memory, wherein the computer executable components comprise:
a carbon footprint component that generates estimated carbon footprints of a plurality of tasks for a plurality of datacenters based on carbon intensity forecasts and estimated workload requirements of the plurality of tasks, wherein the carbon intensity forecasts comprise ancillary carbon output, marginal carbon output, and average carbon output; and
a scheduling component that schedules the plurality of tasks for one or more datacenters selected from the plurality of datacenters based on the estimated carbon footprints.

2. The system of claim 1, wherein the computer executable components further comprise a forecast component that generates the carbon intensity forecasts for the plurality of datacenters.

3. The system of claim 1, wherein the computer executable components further comprise a workload component that generates the estimated workload requirements of the plurality of tasks for the plurality of datacenters, wherein the estimated workload requirements comprise existing workloads and anticipated workloads.

4. The system of claim 3, wherein the estimated workload requirements comprise a level of flexibility, runtime duration, and power output.

5. The system of claim 3, wherein the estimated workload requirements further comprise anticipated task transfer operations.

6. The system of claim 1, wherein the ancillary carbon output is based on ancillary power generation sources, the marginal carbon output is based on increases in marginal energy generation sources, and the average carbon output is based on a standard market clearing source.

7. The system of claim 1, wherein the scheduling component further:
determines a combination of tasks and datacenters based on solving a mixed integer linear problem; and
schedules the plurality of tasks for the one or more datacenters selected from the plurality of datacenters based on the combination of tasks and datacenters.

8. A computer implemented method comprising:
generating, by a system operatively coupled to a processor, estimated carbon footprints of a plurality of tasks for a plurality of datacenters based on carbon intensity forecasts and estimated workload requirements of the plurality of tasks, wherein the carbon intensity forecasts comprise ancillary carbon output, marginal carbon output, and average carbon output; and
scheduling, by the system, the plurality of tasks for one or more datacenters selected from the plurality of datacenters based on the estimated carbon footprints.

9. The computer implemented method of claim 8, further comprising, generating, by the system, the carbon intensity forecasts for the plurality of datacenters.

10. The computer implemented method of claim 8, further comprising, generating, by the system, the estimated workload requirements of the plurality of tasks for the plurality of datacenters, wherein the estimated workload requirements comprise existing workloads and anticipated workloads.

11. The computer implemented method of claim 8, wherein the ancillary carbon output is based on ancillary power generation sources, the marginal carbon output is based on increases in marginal energy generation sources, and the average carbon output is based on a standard market clearing source.

12. The computer implemented method of claim 8, wherein the estimated workload requirements comprise a level of flexibility, runtime duration, and power output.

13. The computer implemented method of claim 8, further comprising:
determining, by the system, a combination of tasks and datacenters based on solving a mixed integer linear problem; and
scheduling, by the system, the plurality of tasks for the one or more datacenters selected from the plurality of datacenters based on the combination of tasks and datacenters.

14. The computer implemented method of claim 10, wherein the estimated workload requirements further comprise anticipated task transfer operations.

15. A computer program product, comprising a computer readable storage medium having program instructions embodied therewith, the program instructions executable by a processor to cause the processor to:
generate, by the processor, estimated carbon footprints of a plurality of tasks for a plurality of datacenters based on carbon intensity forecasts and estimated workload requirements of the plurality of tasks, wherein the carbon intensity forecasts comprise ancillary carbon output, marginal carbon output, and average carbon output; and
scheduling, by the processor, the plurality of tasks for one or more datacenters selected from the plurality of datacenters based on the estimated carbon footprints.

16. The computer program product of claim 15, wherein the program instructions are further executable to cause the processor to generate, by the processor, the carbon intensity forecasts for the plurality of datacenters.

17. The computer program product of claim 15, wherein the program instructions are further executable to cause the processor to generate, by the processor, the estimated workload requirements of the plurality of tasks for the plurality of datacenters, wherein the estimated workload requirements comprise existing workloads and anticipated workloads.

18. The computer program product of claim 15, wherein the ancillary carbon output is based on ancillary power generation sources, the marginal carbon output is based on increases in marginal energy generation sources, and the average carbon output is based on a standard market clearing source.

19. The computer program product of claim 17, wherein the estimated workload requirements comprise a level of flexibility, runtime duration, and power output.

20. The computer program product of claim 15, wherein the program instructions are further executable to cause the processor to:
determine, by the processor, a combination of tasks and datacenters based on solving a mixed integer linear problem; and
schedule, by the processor, the plurality of tasks for the one or more datacenters selected from the plurality of datacenters based on the combination of tasks and datacenters.
